(19) United States
(12) Patent Application Publication
(10) Pub. No.: US 2023/0289718 A1
(43) Pub. Date: Sep. 14, 2023

(54) ITEM CIRCULATION TRACKING PROCESSING METHOD, DEVICE AND STORAGE MEDIUM

(71) Applicant: SHANGHAI BINLI TECHNOLOGY CO., LTD., Shanghai (CN)

(72) Inventor: Wenyun Niu, Shanghai (CN)

(21) Appl. No.: 18/016,583

(22) PCT Filed: Dec. 28, 2020
(86) PCT No.: PCT/CN2020/139850

§ 371 Date: Jan. 17, 2023

(30) Foreign Application Priority Data
Jul. 17, 2020 (CN) 202010692717.2

(51) Int. Cl. G06Q 10/087; G06V 20/50; G06V 30/192; G06V 10/94

(52) U.S. Cl. CPC G06Q 10/087; G06V 10/945; G06V 20/50; G06V 30/192

(57) ABSTRACT

Provided is an item circulation tracking processing method, in this method, an item is taken as a tracking object, and the whole process from purchase to use of an item on any household shopping receipt may be tracked, so as to achieve a full-flow automatic tracking processing of the item after entering the household, serve as a good helper for household item management, and provide a reliable reference for future consumption planning. Further provided are an item circulation tracking processing apparatus, device and a readable storage medium, which have the above beneficial effects, and are not described herein again.

### CROSS REFERENCE TO RELATED APPLICATION(S)

This is a national stage application filed under 37 U.S.C. 371 based on International Patent Application No. PCT/CN2020/139850, filed on Dec. 28, 2020, which claims priority to Chinese Patent Application No. 202010692717.2 filed with the China National Intellectual Property Administration (CNIPA) on Jul. 17, 2020 and entitled “item circulation tracking processing method and related assembly”, the disclosure of which is incorporated herein by reference in its entirety.

### TECHNICAL FIELD

The present application relates to the field of item tracking processing technologies, and in particular, to an item circulation tracking processing method, an item circulation tracking processing apparatus, device and a readable storage medium.

### BACKGROUND

There are many items in the household, including all kinds of food, such as eggs, milk, vegetables and fruits, and all kinds of electric appliances, and it is difficult to properly manage all kinds of items after they are purchased. For example, in terms of the management of food fresh-keeping period, it often occurs that food is out of date; food in a freezer compartment of a refrigerator is often kept for more than one year while the longest storage time of the food recommended by the nutritionist is 90 days. For another example, in terms of the warranty and maintenance of the electric appliances, it often occurs that people always forgets whether the electric appliances are still under warranty or how long the electric appliances need to be maintained, and the like. When you are shopping, you will get a shopping receipt, and sometimes you may take the shopping receipt out to check the time of purchase, what being purchased, whether the maintaining being needed, and other information.

At present, an item management mainly includes the following methods: after bar codes are pasted on household items, the bar codes are scanned through a mobile phone, and item information is sent to a cloud management platform to achieve the management of freshness / quality guarantee / warranty of foods and items; in the application of the mobile phone, information such as food names, time of purchase, and fresh-keeping time is manually input, and a fresh-keeping reminding is then performed by combining with a calendar; for the management of the shopping receipts, a small program scheme “order management” provided for merchants exists on a WeChat platform, the merchants provide commodity purchase vouchers (electronic vouchers) for ordering users, the user may search which merchant a certain item is purchased from and conveniently find, through the small program scheme “order management”, a corresponding merchant when the item needs to be maintained; and the user may obtain an electronic shopping receipt by scanning QR codes provided by the merchant after the user pays for a purchase. It should be noted that, the scheme “order management” of the WeChat platform only provides management of the shopping receipts in the WeChat platform but cannot provide management of shopping receipt in other platforms.

The manners of pasting the bar codes on the household items and manually inputting in the application of the mobile phone is time-consuming and labor-consuming and is only suitable for a few kinds of items, and the bill management cannot be achieved at the same time; the existing bill management scheme is only suitable for online shopping bills or ready-made electronic bills, but is not suitable for paper shopping receipts generated by an offline shopping.

Therefore, how to improve the tracking processing efficiency of the household items and improve the user experience is a problem that needs to be solved urgently by those skilled in the art.

### SUMMARY

An objective of the present application is to provide an item circulation tracking processing method, which can improve the tracking processing efficiency of household items and the user experience; another objective of the present application is to provide an item circulation tracking processing apparatus, device and a readable storage medium.

There is provided an item circulation tracking processing method. The method includes that: a shopping receipt is acquired by at least one of importing an online shopping receipt or receiving an electronic offline shopping receipt; basic information is identified in the shopping receipt, the basic information is added to a table entry corresponding to the shopping receipt in a shopping receipt summary table, and a storage address of the shopping receipt is added to the table entry corresponding to the shopping receipt in the shopping receipt summary table, where the basic information includes a merchant and time of purchase; purchase information of each item of at least one item in the shopping receipt is identified, the purchase information of each item is added to an item summary table, and a shopping receipt corresponding to each item is associated with a table entry corresponding to each item in the item summary table, where the purchase information of each item includes the merchant, the time of purchase, an item name, an item quantity, and unit price of each item; and a life reminder is made according to the item summary table.

Optionally, that the shopping receipt is acquired by the at least one of importing the online shopping receipt or receiving the electronic offline shopping receipt includes: a storage region corresponding to each offline merchant is established in a shopping receipt collection management region to add a file or a directory to the storage region, where the storage region is used to store the electronic offline shopping receipt of each offline merchant; a picture file of the electronic offline shopping receipt is received, and the picture file is taken as an electronic original shopping receipt which is stored in the storage region corresponding to each merchant in the shopping receipt collection management region; an optical character recongnition (OCR) tool is called to perform a character recognition on the electronic original shopping receipt in the shopping receipt collection management region to obtain a character file; and the character file is taken as an identifiable shopping receipt corresponding to the electronic original shopping receipt and is stored in the storage region corresponding to each offline merchant in the shopping receipt collection management region.

Optionally, before taking the character file as the identifiable shopping receipt corresponding to the electronic original shopping receipt and storing the character file in the storage region corresponding to each offline merchant in the shopping receipt collection management region, the method further includes that: a correction output by a user is performed on the character file; and if the user confirms that no error exists in the character file, then the step of storing the character file in the storage region corresponding to each offline merchant in the shopping receipt collection management region is performed.

Optionally, that the shopping receipt is acquired by the at least one of importing the online shopping receipt or receiving the electronic offline shopping receipt includes that: a storage region corresponding to each online merchant is established in a shopping receipt collection management region, where the storage region is used to store the online shopping receipt; and the online shopping receipt is stored in the storage region corresponding to an online merchant of the online shopping receipt.

Optionally, that the purchase information in the shopping receipt is identified includes that: a shopping receipt template corresponding to a merchant of the shopping receipt is searched or generated; and according to a position of purchase information in the shopping receipt template, information of a position corresponding to the position of purchase information in the shopping receipt template is read from the shopping receipt to obtain the purchase information of each item.

Optionally, that the life reminder is made according to the item summary table includes that: reminding time of each item is determined according to a fresh-keeping period or a maintenance period or a maintenance warranty period, the time of purchase, and advanced reminding time of each item, then an item consumption reminding is made according to the reminding time.

Optionally, the life reminder is made according to the item summary table includes that: destination information of each item in the item summary table added by a user is received, and a table entry management on the item summary table is managed according to the destination information.

Optionally, the item circulation tracking processing method further includes that: a household item management reminder is performed according to the destination information; where the household item management reminder includes at least one of a shopping list management to be bought, a healthy diet management, or a living garbage classification reminder.

Optionally, that the life reminder is made according to the item summary table includes that: a household financial reminder is performed according to the item summary table.

There is provided an item circulation tracking processing apparatus. The apparatus includes a shopping receipt acquisition unit, a shopping receipt statistics unit, an item summary unit and a life reminding unit. The shopping receipt acquisition unit is configured to acquire a shopping receipt by at least one of importing an online shopping receipt or receiving an electronic offline shopping receipt. The shopping receipt statistics unit is configured to identify basic information in the shopping receipt, add the basic information to a table entry corresponding to the shopping receipt in a shopping receipt summary table, and add a storage address of the shopping receipt to the table entry corresponding to the shopping receipt in the shopping receipt summary table, where the basic information includes a merchant and time of purchase. The item summary unit is configured to identify purchase information of each item in the shopping receipt, add the purchase information of each item to an item summary table, and associate a shopping receipt corresponding to each item with a table entry corresponding to each item in the item summary table, where the purchase information of each item includes the merchant, the time of purchase, an item name, an item quantity, and unit price of each item. The life reminding unit is configured to make a life reminder according to the item summary table.

There is provided an item circulation tracking processing device. The device includes a processor and a memory for storing a computer program. The computer program, when executed by the processor, causes the processor to perform steps of the item circulation tracking processing method.

There is provided a readable storage medium. The readable storage medium stores a program, the program, when executed by a processor, implements steps of the item circulation tracking processing method.

According to the item circulation tracking processing method provided in the present application, the item may be taken as a tracking object, and the whole process from purchase to use of an item listed on any household shopping receipt may be tracked to achieve a full-flow automatic tracking processing of the item after entering the household, serve as a good helper for household item management, and provide a reliable reference for future consumption planning.

The present application further provides an item circulation tracking processing apparatus, device and a readable storage medium, which have the above beneficial effects, and are not described herein again.

### BRIEF DESCRIPTION OF DRAWINGS

In order to more clearly explain the technical schemes in embodiments of the present application or in the existing art, the drawings used for describing the embodiments or the existing art will be briefly introduced below. Apparently, the drawings in the following description are merely the embodiments of the present application, and for those of ordinary skill in the art, other drawings may also be obtained based on these drawings without any creative efforts.

FIG. 1 is a flowchart of an item circulation tracking processing method provided in an embodiment of the present application;

FIG. 2 is a structural block diagram of an item circulation tracking processing apparatus provided in an embodiment of the present application; and

FIG. 3 is a structural diagram of an item circulation tracking processing device provided in an embodiment of the present application.

### DETAILED DESCRIPTION

The core of the present application is to provide an item circulation tracking processing method, this method can improve the tracking processing efficiency of household items and the user experience; the other core of the present application is to provide an item circulation tracking processing apparatus, device and a readable storage medium.

In order to make the objectives, technical schemes and advantages of embodiments of the present application clearer, the technical schemes in the embodiments of the present application will be described clearly and completely below in conjunction with the drawings in the embodiments of the present application. Apparently, the described embodiments are merely part of the embodiments of the present application, rather than all of the embodiments of the present application. All other embodiments obtained by those of ordinary skill in the art based on the embodiments of the present application without requiring creative efforts shall all fall within the scope of protection of the present application.

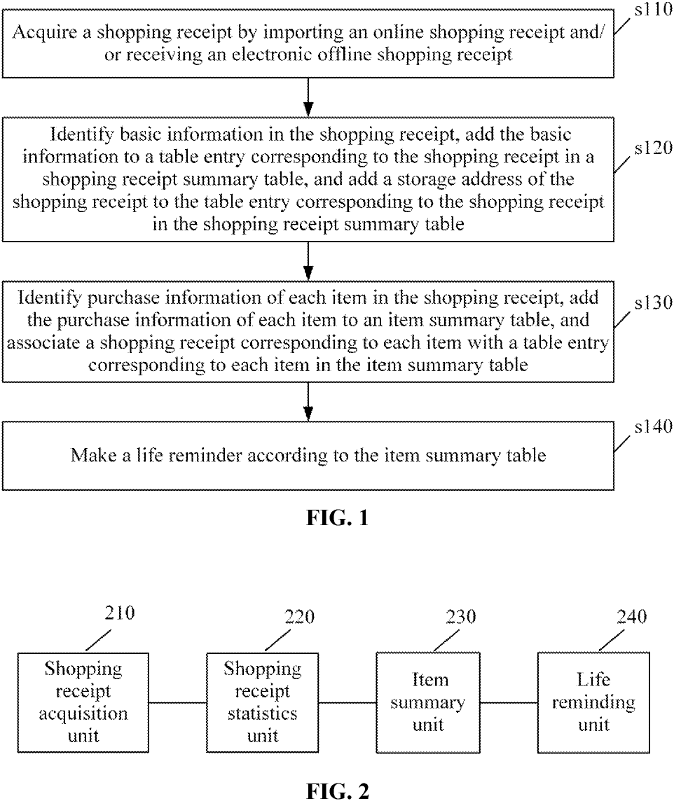

The circulation of the items mainly includes two aspects: shopping and using at home, both an item management scheme and a shopping receipt management scheme in the existing art only involves one aspect. The shopping receipt management scheme only involves a shopping stage but does not involve a management of items after the items arrive at household, and management for the items is inconvenient. The item management scheme only involves a stage of placing items into the home but does not involve the storage and search of corresponding shopping receipts. In order to achieve the comprehensive and rapid item circulation tracking processing, this embodiment provides an item circulation tracking processing method. Referring to FIG. 1, FIG. 1 is a flowchart of an item circulation tracking processing method provided in an embodiment of the present application, and the method mainly includes following steps.

In step s110, a shopping receipt is acquired by importing an online shopping receipt and/or receiving an electronic offline shopping receipt.

The shopping receipt is a receipt which is generated by a merchant and contains merchant information and purchased item information, and may also be referred to as a “payment receipt”, and the shopping receipt after being imported is referred to as a “shopping receipt” in this embodiment. A source of the shopping receipt mainly include: a QR code being scanned on the spot to acquire the shopping receipt after finishing a shopping in a shopping mall; the shopping receipt being generated after the online shopping; the shopping receipt being from a membership bill mail; the shopping receipt being from a paper shopping receipt; or the shopping receipt being from an invoice.

For kinds of shopping receipts from different sources, in order to facilitate the overall management of the shopping receipts, a shopping receipt collection region may be established, where the shopping receipt collection region includes multiple interface manners for receiving shopping receipt information, the interface manners respectively correspond to an online shopping receipt management and an offline shopping paper shopping receipt management, a storage region corresponding a merchant name of this merchant is established for each merchant and is used for storing shopping information generated by the merchant, the storage region may be built in a form of a file, and the file is formed with a file name including the merchant name, or the file is added with a file tag of the merchant; alternatively, the storage region may be built in a directory form, and individual sub-directories are set up for each merchant. The building form of the storage region is not limited in this embodiment but is mainly described in the form of setting up individual sub-directories for each merchant in the following description, and other manners may refer to the description of this embodiment, which is not described herein again. The paper shopping receipt management may be implemented by taking a picture of the paper shopping receipt to form an electronic document or scanning the paper shopping receipt to form an electronic document and then storing the electronic document.

A specific implementation manner of importing the shopping receipt is not limited, optionally, a method for importing the offline paper shopping receipt is as follows.

A storage region corresponding to each offline merchant is established in a shopping receipt collection management region, where the storage region is used to store an offline shopping receipt corresponding to each offline merchant.

A corresponding storage region is established for each offline merchant for storing a shopping receipt generated by a corresponding offline merchant.

A picture file of the offline shopping receipt is received, and the picture file is taken as an electronic original shopping receipt and is then stored in a storage region of a corresponding merchant in the shopping receipt collection management region; and

A photo is taken on a paper shopping receipt (for example, a photo is taken with a mobile phone), a picture file is formed (such as, a .jpeg file, a .jpg file, a .png file, or a .pdf file), and the picture file is stored in the shopping receipt collection management region.

An optical character recognition (OCR) tool is called to perform a character recognition on the electronic original shopping receipt in the shopping receipt collection management region to obtain a character file. The optical character recognition (OCR) tool is used for recognizing the picture file into a corresponding character file (such as, a .csv file or a .txt file), and then the character file is stored in the shopping receipt collection management region, the OCR has higher recognition precision on the character of the shopping receipt, thus it can ensure the character recognition precision. In this embodiment, only the OCR is taken as a character recognition manner as an example for introduction, other character recognition manners are not described herein again and may refer to the introduction of this embodiment.

The character file is taken as an identifiable shopping receipt corresponding to the electronic original shopping receipt and is stored in a storage region of a corresponding merchant in the shopping receipt collection management region.

Furthermore, in order to prevent a recognition software from making mistakes, the user may correct and confirm a character file obtained by an automatic recognition to ensure the accuracy of a recognizable electronic shopping receipt, and before the character file is stored in the shopping receipt collection management region as an identifiable shopping receipt corresponding to an electronic original shopping receipt, a correction output by the user may be performed on the character file; if the user confirms that the character file is correct, then the step of storing the character file into the storage region corresponding to each merchant in the shopping receipt collection management region is performed, if the user determines that the character file is incorrect, then the user may directly modify the character file until the user confirms that the character file is correct, and the character file is imported into a storage region of a corresponding merchant in the shopping receipt collection region. Of course, the step of correcting the character file may not be performed, and this is not limited in this embodiment.

Optionally, a method for importing an online electronic shopping receipt is as follows.
(1) a storage region corresponding to each online merchant is established in a shopping receipt collection management region, where the storage region is used to store an online shopping receipt corresponding to each online merchant;
(2) the online shopping receipt is stored in the storage region corresponding to an online merchant of the online shopping receipt.

The method for receiving the online electronic shopping receipt may be as follows: the electronic shopping receipt is directly downloaded to a storage region corresponding to the online merchant in the shopping receipt collection management region established in the present application, so that the electronic shopping receipt may be directly obtained through the storage region when being checked and it is convenient to check because the networking is not needed.

While some electronic shopping receipts may not allow import or download, and in this case, a link may be directly made to a generator of the electronic shopping receipt so that the shopping receipt can be checked through networking.

In this embodiment, only the shopping receipt importing method described above being taken as an example is described, other importing manners (e.g., manual importing) may also be adopted, and the descriptions of this embodiment may be referred to for the other importing manners, which are not described herein again.

In step s120, basic information in the shopping receipt is identified, the basic information is added to a table entry corresponding to the shopping receipt in a shopping receipt summary table, and a storage address of the shopping receipt is added to the table entry corresponding to the shopping receipt in the shopping receipt summary table.

The basic information includes a merchant and time of purchase; and a merchant name is determined according to a name of a sub-directory where each shopping receipt file is located. Since a shopping receipt file is generally generated at the same time of purchasing behaviors of users, the time of purchase may be determined according to an original establishing time of each file, and if there is time discrepancy between the determined time of purchase and the real time of purchase, the user may modify it by himself. Moreover, information such as a source of the shopping receipt and a shopping receipt number (for convenience of finding a shopping receipt file, a number may be assigned to the shopping receipt file) may be further configured in the basic information, the specific information type of the basic information is not limited in this embodiment, and one type of shopping receipt summary table is shown in Table 1 below.

The shopping receipt summary table includes basic information of various shopping receipts and the corresponding storage address of the shopping receipts, and it should be noted that the same objective may be achieved by loading the corresponding address link in the shopping receipt storage region on a shopping receipt file name or loading the corresponding address link on a shopping receipt number.

An appropriate management of the shopping receipt may be achieved by using the shopping receipt summary table, it is convenient for the user to check the receipt and to find the original shopping receipt quickly when the product has problems so as to contact with the merchant quickly.

TABLE 1

Shopping receipt summary table

| | | | |
|---|---|---|---|
| Shopping receipt number | Shopping receipt file name | Merchant | Time of purchase |

In step s130, purchase information of each item in the shopping receipt is identified, the purchase information is added to an item summary table, and a shopping receipt corresponding to each item is associated with a table entry corresponding to each item in the item summary table.

Purchase information of each item in the shopping receipt is identified, where the specifically identified purchase information mainly includes: the merchant, the time of purchase, an item name, an item quantity, and unit price of each item. The purchase information of each item may further include other information besides the above information, or the information described above may be deleted, which is not limited in this embodiment.

In this embodiment, a manner of identifying the purchase information of each item in the shopping receipt is not limited, optionally, a manner of identifying the purchase information of each item in the shopping receipt includes as described below.
(1) A shopping receipt template corresponding to a merchant of the shopping receipt is searched or generated; and
(2) According to a position of purchase information in the shopping receipt template, information of a position corresponding to the position of purchase information in the shopping receipt template is read from the shopping receipt to obtain the purchase information.

A template library of the shopping receipt is established in advance, and the template library provides positions of purchase information in the shopping receipts of various merchants, for example, a template format of an electronic shopping receipt (which may be an electronic paper shopping receipt or an online shopping receipt) of a supermarket may be as shown in the following template 1. In this template 1, information of merchants, time of purchase, item names and quantities and amounts of purchases, and locations of rows and columns in which all the information is located (ignoring all empty rows and empty columns in the shopping receipt) are included.

Template 1

| | | | | |
|---|---|---|---|---|
| | (Column 1) | (Column 2) | (Column 3) | (Column 4) |
| (Row 1) | Merchant name | | | |
| (Row 2) | Time of purchase | | | |
| (Row 3) | Item name | Quantity | Unit price | Total price |
| (Row 4) | Specific item name 1 | Quantity number1 | Unit price 1 | Total price 1 |
| (Row 5) | Specific item name 2 | Quantity number2 | Unit price 2 | Total price 2 |
| ...... | ...... | ...... | ...... | ...... |
| (Row n+3) | Specific item name n | Quantity number n | Unit price n | Total price n |
| (Last row) | Collection | | | Total amount |

As shown above, the template of an electronic shopping receipt is a schematic, and template forms of other electronic shopping receipts are not described in detail herein.

Another example of the template is shown as the following template 2, the template is for a text file after the paper shopping receipt being electronized, these files are usually a .txt file or a .csv file, a separator between character phrases in the .txt file is usually a space or “,”, a separator between character phrases in the .csv file is usually “,”, a file in which the separator “,” is used between the character phrases is taken as an example here, a sequence number of the character phrase is taken as a column number, other template settings based on the text file may refer to the following description and are not described herein again.

Template 2

| | |
|---|---|
| | (Column 1)(Column 2)(Column 3)(Column 4) |
| (Row 1) | Merchant name |
| (Row 2) | Time of purchase |
| (Row 3) | Item name, Quantity, Unit price, Total price |
| (Row 4) | Specific item name 1, Quantity number 1, Unit price 1, Total price 1 |
| (Row 5) | Specific item name 2, Quantity number 2, Unit price 2, Total price 2 |
| ...... | |
| (Row n) | Specific item name n, Quantity number n, Unit price n, Total price n |
| (Row n+1) | Collection, Total amount |

For each shopping receipt in the shopping receipt storage region or all newly added shopping receipts, whether a corresponding template exists in the template library is searched according to merchant information such as a merchant name, if a template exists, corresponding information is read out from a specified position by referring to the template, and the corresponding information is added into the item summary table; if no template exists, a template may be newly built and added into the template library, and then an information identification reading operation is executed according to the newly built template.

A method for newly building a template includes the following steps.

The user is reminded to separately input pieces of information such as merchant names, time of purchase, item names, specific items, purchase quantity, unit prices, and total price, and the user opens the electronic shopping receipt file to select each position in the receipt file which contains information of each position and press a return key to confirm the selected position.

The system locates the information in the electronic shopping receipt file of the shopping receipt to obtain a specific position of each information in the file, and after all information is collected, the system generates a template of the merchant as shown in the template 1 or the template 2 and stores the template of the merchant in the template library.

The above description is given for an example of the identification manner for the purchase information of each item in the shopping receipt based on the template, and other identification manners may refer to the above description and are not described herein again.

The purchase information of each item in the shopping receipt is identified, the purchase information of each item is added to the item summary table, and the shopping receipt corresponding to each item is associated with the table entry corresponding to each item in the item summary table, for example, the shopping receipt is linked to the shopping receipt number in the item summary table, so that the user may check the shopping receipt corresponding to each item when viewing the item in the item summary table. The part to which the reference point is related is not limited in this embodiment, and may be set according to actual needs.

The shopping receipt being linked to the corresponding shopping receipt number in the item summary table is taken as an example, as shown in the following Table 2-1, the following Table 2-1 shows an item summary table, and by double-clicking the shopping receipt number in the table 2-1, a corresponding shopping receipt may be found and opened according to Table 1, so that the shopping receipt information corresponding to each item may be conveniently checked.

TABLE 2-1

Item summary table

| | | | | | |
|---|---|---|---|---|---|
| Shopping receipt number | Merchant | Time of purchase | Item name | Quantity | Unit price |

In step s140, a life reminder is made according to the item summary table.

The item summary table includes related information of all purchased items, so that effective management of the items is realized, the item summary table may be directly output, so that the user may know the current existing items in real time, and in order to facilitate the use of the item by the user, in this embodiment, the life reminder is performed according to the item summary table, for example, the fresh-keeping period of a certain item is up, the user is reminded to eat the certain item as soon as possible; for another example, the egg stock is insufficient, a supplement is needed as soon as possible, the specific implementation manner of the life reminder in this embodiment is not limited, and the life reminder may be set according to the actual user usage requirement.

Based on the above descriptions, according to the item circulation tracking processing method provided in this embodiment, the item is taken as the tracking object, and the whole process from purchase to use of an item on any household shopping receipt may be tracked, so as to achieve a full-flow automatic tracking processing of the item after entering the household, serve as a good helper for household item management, and provide a reliable reference for future consumption planning.

In the above embodiments, specific implementation manners of making the life reminder according to the item summary table are not limited, and several implementation manners of life reminder are mainly described in this embodiment.

1. Optionally, the life reminder being made according to the item summary table may specifically be: the reminding time of each item is determined according to the fresh-keeping period / the maintenance period /the maintenance warranty period, the time of purchase and the advanced reminding time of each item, then an item consumption reminding is performed according to the reminding time.

A process of determining the fresh-keeping period / the maintenance period / the maintenance warranty period of each item may be added by the user, that is, the user adds the fresh-keeping period / the maintenance period / the maintenance warranty period of each item; it may also be added automatically, for example, a common fresh-keeping period /a maintenance period /a maintenance warranty period is determined based on a type of the item. An identification manner for automatically determining the fresh-keeping period /the maintenance period / the maintenance warranty period of each item is described below.

In order to simplify the comparison of items and to determine the fresh-keeping period / the maintenance period / the maintenance warranty period corresponding to each item category, each item may be classified according to the item name in the item summary table, and a column of ‘category’ or multiple columns of category classes may be added to the item summary table to form a Table 2-2. The classification method may be classified into food, electrical appliances, and daily use items according to the conventional item classification method; it may also be classified according to storage location, for example, the food categories may be classified into: outdoor, indoor, refrigerator freezer compartment, refrigerator refrigerating compartment, which is not limited here. Furthermore, each item may be numbered for ease of management.

TABLE 2-2

Classified item summary table

| | | | | | | | |
|---|---|---|---|---|---|---|---|
| Shopping receipt number | Merchant | Time of purchase | Category | Item number | Item name | Quantity | Unit price |

The default information of fresh-keeping, quality guarantee and warranty of all kinds of items established in advance shall be called to determine the preservation period / the maintenance period / the maintenance warranty period of all kinds of items in the item summary. According to the actual needs of the user, the “fresh-keeping/maintenance/maintenance warranty period” may be a cycle or a time length, which is not limited herein. A classified item information table may be generated according to the fresh-keeping period / the maintenance period / the maintenance warranty period and item category corresponding to each item, which simplifies the table entry and facilitates the user to check. As shown in the following Table 3, the Table 3 is the classified item information table. More information may be added to the Table 3, such as: storage location, adding category or more category columns, which is not limited herein, and may be set according to the actual use needs. The classification information table in other forms is not described again in this embodiment.

TABLE 3

Classified item information table

| | | | |
|---|---|---|---|
| Item number | Item name | Category | Fresh-keeping period / maintenance period / maintenance warranty period |

The warranty period and the like period of each item may be determined directly without classifying the items in the Classified item information table. If the items are not classified, the table entry “Category” in Table 3 is empty, only the item summary table shown in Table 2-1 is available, and Table 2-2 is not generated.

Advanced reminding time is the time to remind before the expiration. The advanced reminding time may be set by the user or may be a default value set automatically, which is not limited here.

The reminding time of each item may be obtained according to the time of purchase, the fresh-keeping period / the maintenance period / the maintenance warranty period and the advanced reminding time of each item, then time of purchase + fresh-keeping period /maintenance period /maintenance warranty period - advanced reminding time = reminding time.

The reminding time may be added to the table entry to facilitate the user to check the reminding time. The item information in Table 2-1 or Table 2-2, including the “time of purchase” information, and the information in Table 3 will be combined into Table 4, and a column “advanced reminding time” will be added to Table 4, i.e., the user will be reminded how long the item is about to arrive at the “fresh-keeping period / the maintenance period / the maintenance warranty period”. The time period from the “time of purchase” to the time of reminding the user is “the fresh-keeping period / the maintenance period / the maintenance warranty period” minus “advanced reminding time.”

TABLE 4

Classified item and classified information summary table

| | | | | | |
|---|---|---|---|---|---|
| Item number | Item name | Category | Time of purchase | Fresh-keeping period / maintenance period / maintenance warranty period | Advanced reminding time |

Combined with the calendar function, the “time of purchase” in Table 4 is taken as the starting of the timing day. After the timing duration, the user is reminded to make consumption or maintenance or warranty actions. If the fresh-keeping period / the maintenance period / the maintenance warranty period is a cycle, then this reminding also needs to be set to periodic in the calendar.

A manner of item consumption reminding when the reminding time arrives is not limited, but it may adopt an output and displayed manner, for example, the item entry is marked red and output to a screen, or may be voice reminding, for example, the reminding voice of an item about to expire is output regularly, or may be reminded in other manners, which is not limited herein.

2. Optionally, that the life reminder is made according to the item summary table may specifically include that: the addition of a user to destination information of each item in the item summary table is received, and a table entry of the item summary table is managed according to the destination information.

The destination information refers to the final destination of the item circulation, and may include various destination types such as being eaten, being sent out, or being discarded. By acquiring the destination information and managing the table entry according to the destination information, the user may conveniently acquire the destination information of the item, and achieve the household management according to the item destination information.

Specifically, a destination information management manner is as follows: an item consumption management database containing the destination of an item after leaving home: consumed, recycled, sent out, discarded, and the like, that the table entry management of the item summary table is performed according to the destination information may specifically add the destination information (including consumption or discarding time) to the item summary table 2-1 or the classified item summary table 2-2, and if the table 2-2 is taken as an example, then the result is as shown in Table 5; or historical data may be formed from the items consumed; and the table entry of the consumed items in the item summary receipt may be directly deleted so as to realize the timely update of the table entry.

TABLE 5

Summary table of item classification and destination

| | | | | | | | | | |
|---|---|---|---|---|---|---|---|---|---|
| Shopping receipt number | Merchant | Time of purchase | Category | Item number | Item name | Quantity | Unit price | Consumption or discard time | item destination |

An entire process of an item from being bought into the door to being consumed may be found from Table 5. In the middle, Table 4 may be used for reminding of timely consumption or maintenance, maintenance/warranty of the item. If all tables are built into a database format, then this is a relational database, where the item name or item number is taken as a primary key, the shopping receipt number is taken as a foreign key to form an association with the shopping receipt summary table, the entire process of items on any one receipt of household items may be tracked in steps from being purchased, being used, to being consumed.

Furthermore, a household item management reminder may also be made based on the destination information; where the household item management may include at least one of: a shopping list management to be bought, a healthy diet management, or a living garbage classification reminder.

The household item management reminder may be made based on the destination information, for example, the destination information of items is managed for reference of a next shopping, for example, eggs are empty currently, eggs are in the next shopping list; in addition, consumption management of food categories may also serve as an important data source for healthy diet management, the item destination information may also be analyzed for healthy eating, for example, when large amounts of chocolate are consumed in a short period of time, the user may be reminded of excessive caloric intake in short periods, etc., as to where the food categories may be re-refined in the destination to be consumed by family members so as to facilitate recipes and health management for each family member; a living garbage classification reminder may also be made, such as in conjunction with the living garbage classification guidelines for four categories of items published in China, building the living garbage classification guidelines for living garbage classification guidelines, as shown in Table 6, it is indicated that which category of garbage a certain item should fall into and that which category of garbage a certain category of items should fall into with reference to this table and items category of the consumed items.

In this embodiment, a table entry processing manner according to item destination information is not limited, and may be set according to actual user usage needs.

TABLE 6

Living garbage classification guideline

| | |
|---|---|
| Item name | Garbage classification |
| | Harmful garbage |
| | Recyclable |
| | wet garbage |
| | dry garbage |

In execution, this embodiment may require the establishment and invocation of several databases, such as a template library, an item classification library, a garbage classification guideline library, all databases may be local or in the cloud or in a user-server mode, for example the user uploads an electronic shopping receipt to a web server; shopping receipt templates for all merchants are established on the web server side, and accounts are established for each user; a corresponding identification is performed after the user uploads the bill; user shopping receipts, user item list, reminding settings, consumption destination, and the like are aggregated for user to use interactively at any time, without limitation as to a storage end of the database.

It should be noted that, in this embodiment, a manner in which the household item management reminder is specifically executed is not specifically limited, one or more of the shopping list managements to be bought, the healthy diet management, or the living garbage classification reminder may be performed, the other management reminder may also be performed, for example, an item quality-comparing price-comparing function can also be added, due to a fact that the records of purchasing the same item from different merchants exist, the item quality-comparing price-comparing function may be added according to the usage of the item by the user. In this embodiment, the manner for the household item management reminder is not limited, and may be set according to actual use requirements.

3. Optionally, that the life reminder is made according to the item summary table may specifically be: a household financial reminder is performed according to the item summary table.

The household financial reminder is made based on purchase information of each item in the item summary table, since the purchase receipt contains information such as item name, time of purchase, and price, the total monthly expenses and specific expense categories may be summarized, so that expenditure is clear, and the financial management processing is helpful for the user. Of course, this step may not be performed, and is not limited herein.

Referring to FIG. 2, FIG. 2 is a structural block diagram of an item circulation tracking processing apparatus provided in this embodiment. The apparatus mainly includes a shopping receipt acquisition unit 210, a shopping receipt statistics unit 220, an item summary unit 230 and a life reminding unit 240. The item circulation tracking processing apparatus provided in this embodiment may be cross-checked with the above item circulation tracking processing method.

The shopping receipt acquisition unit 210 is mainly configured to acquire a shopping receipt by importing an online shopping receipt and/or receiving an electronic offline shopping receipt. The shopping receipt statistics unit 220 is mainly configured to identify basic information in the shopping receipt, add the basic information to a table entry corresponding to the shopping receipt in a shopping receipt summary table, and add a storage address of the shopping receipt to the table entry corresponding to the shopping receipt in the shopping receipt summary table, where the basic information includes a merchant and time of purchase. The item summary unit 230 is mainly configured to identify purchase information of each item in the shopping receipt, add the purchase information of each item to an item summary table, and associate a shopping receipt corresponding to each item with a table entry corresponding to each item in the item summary table, where the purchase information of each item includes the merchant, the time of purchase, an item name, an item quantity, and unit price of each item. The life reminding unit 240 is mainly configured to make a life reminder according to the item summary table.

This embodiment discloses an item circulation tracking processing device which mainly includes a memory for storing a program and a processor.

The processor is configured to, when executing the program, perform steps of the item circulation tracking processing method described in the above-described embodiments.

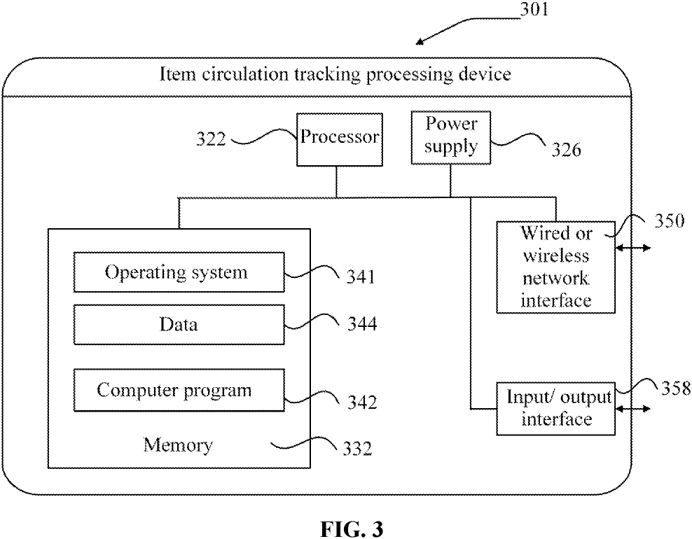

FIG. 3 is a structural diagram of the item circulation tracking processing device provided in an embodiment of the present application. The device may vary due to its different configurations or performance, the device may include at least one processor (such as at least one central processing unit, CPU) 322 and at least one memory 332 for storing at least one computer program 342 or the at least one computer program and computer data 344. Each memory 332 may be a transitory memory or a non-transitory memory. The program stored in each memory may include at least one module (not shown in the figure), and each module may include a series of instruction operations for the data processing device. Further, the CPU 322 may be configured to communicate with the memory 332 and perform the series of instruction operations stored in each memory in the item circulation tracking processing device 301.

The item circulation tracking processing device 301 may further include at least one power supply 326, at least one wired or wireless network interfaces 350, at least one input / output interfaces 358, and / or at least one operating system 341 such as Window Server, Mac OS x, Unix, Linux, FreeBSD, and so on.

The steps of the item circulation tracking processing method described in the above FIG. 1 may be performed by the item circulation tracking processing device in the present application.

This embodiment discloses a readable storage medium. The readable storage medium stores a program, the program, when executed by a processor, implements the steps of the item circulation tracking processing method described in the above-described embodiments, and reference may be made specifically to the description of the item circulation tracking processing method in the above-described embodiments.

The readable storage medium may be, in particular, a USB flash drive, a removable hard disk, a read-only memory (ROM), a random access memory (RAM), a magnetic disk, or an optical disc, and other readable storage media that may store a program code.

The embodiments in the specification are described in a progressive manner, each embodiment focuses on differences from other embodiments, and the same and similar parts between the embodiments may be referred to each other. For the apparatus disclosed in the embodiment, since it corresponds to the method disclosed in the embodiments, the description is relatively simple, and the relevant points may be referred to the description of the method section.

Those skilled in the art may further appreciate that the unit and algorithm steps of the examples described in connection with the embodiments disclosed herein may be implemented in an electronic hardware, a computer software, or a combination of both. In order to clearly illustrate the interchangeability of the hardware and software, the composition and steps of the examples have been generally described in the above description by function. Whether these functions are performed in a hardware or software manner depends on the specific application and design constraints of the technical scheme. Those skilled in the art may use different methods for each particular application to implement the described functions, but such implementation should not be considered beyond the scope of the present application.

The steps of the method or the algorithm described in conjunction with the embodiments disclosed herein may be implemented directly in hardware, a software module executed by the processor, or a combination of both. The software module may be placed in a random access memory (RAM), a memory, a read only memory (ROM), an electrically programmable ROM, an electrically erasable programmable ROM, a register, a hard disk, a removable disk, a CD-ROM, or any other forms of storage medium known in the art.

The item circulation tracking processing method, the item circulation tracking processing apparatus, device and the readable storage medium provided in the present application are described in detail above. The principles and implementations of the present application are described herein by using specific examples, and the description of the above embodiments is only used for helping understand the method and its core idea of the present application. It should be noted that, for those of ordinary skill in the art, several improvements and modifications may be made to the present application without departing from the principles of the present application, and these improvements and modifications also fall within the scope of protection of the claims of the present application.

What is claimed is:

1. An item circulation tracking processing method, comprising:
acquiring a shopping receipt by at least one of importing an online shopping receipt or receiving an electronic offline shopping receipt;
identifying basic information in the shopping receipt, adding the basic information to a table entry corresponding to the shopping receipt in a shopping receipt summary table, and adding a storage address of the shopping receipt to the table entry corresponding to the shopping receipt in the shopping receipt summary table, wherein the basic information comprises a merchant and time of purchase;
identifying purchase information of each item of at least one item in the shopping receipt, adding the purchase information of each item to an item summary table, and associating a shopping receipt corresponding to each item with a table entry corresponding to each item in the item summary table, wherein the purchase information of each item comprises the merchant, the time of purchase, an item name, an item quantity, and unit price of each item; and
making a life reminder according to the item summary table.

2. The method of claim 1, wherein acquiring the shopping receipt by the at least one of importing the online shopping receipt or receiving the electronic offline shopping receipt comprises:
establishing a storage region corresponding to each offline merchant in a shopping receipt collection management region to add a file or a directory to the storage region, wherein the storage region is used to store the electronic offline shopping receipt of each offline merchant;
receiving a picture file of the electronic offline shopping receipt, taking the picture file as an electronic original shopping receipt, and storing the electronic original shopping receipt in the storage region corresponding to each offline merchant in the shopping receipt collection management region;
calling an optical character recongnition (OCR) tool to perform a character recognition on the electronic original shopping receipt in the shopping receipt collection management region to obtain a character file; and
taking the character file as an identifiable shopping receipt corresponding to the electronic original shopping receipt and storing the character file in the storage region corresponding to each offline merchant in the shopping receipt collection management region.

3. The method of claim 2, before taking the character file as the identifiable shopping receipt corresponding to the electronic original shopping receipt and storing the character file in the storage region corresponding to each offline merchant in the shopping receipt collection management region, the method further comprises:
performing a correction output by a user on the character file; and
in a case where the user confirms that no error exists in the character file, performing the step of storing the character file in the storage region corresponding to each offline merchant in the shopping receipt collection management region.

4. The method of claim 1, wherein acquiring the shopping receipt by the at least one of importing the online shopping receipt or receiving the electronic offline shopping receipt comprises:
establishing a storage region corresponding to each online merchant in a shopping receipt collection management region, wherein the storage region is used to store an online shopping receipt corresponding to each online merchant; and
storing the online shopping receipt in the storage region corresponding to an online merchant of the online shopping receipt.

5. The method of claim 1, wherein identifying the purchase information in the shopping receipt comprises:
searching or generating a shopping receipt template corresponding to a merchant of the shopping receipt; and
according to a position of purchase information in the shopping receipt template, reading information of a position corresponding to the position of purchase information in the shopping receipt template to obtain the purchase information.

6. The method of claim 1, wherein making the life reminder according to the item summary table comprises:
determining reminding time of each item according to the time of purchase, advanced reminding time of each item, and one of a fresh-keeping period, a maintenance period and a maintenance warranty period; and
making an item consumption reminding according to the reminding time.

7. The method of claim 1, wherein making the life reminder according to the item summary table comprises:
receiving destination information of each item in the item summary table added by a user; and
performing a table entry management on the item summary table according to the destination information.

8. The method of claim 7, further comprising:
performing a household item management reminder according to the destination information; wherein the household item management reminder comprises at least one of a shopping list management to be bought, a healthy diet management, or a living garbage classification reminder.

9. The method of claim 1, wherein making the life reminder according to the item summary table comprises: performing a household financial reminder according to the item summary table.

10. (canceled)

11. An item circulation tracking processing device, comprising:
a memory for storing a computer program;
a processor, when executing the computer program, implements:
acquiring a shopping receipt by at least one of importing an online shopping receipt or receiving an electronic offline shopping receipt;
identifying basic information in the shopping receipt, adding the basic information to a table entry corresponding to the shopping receipt in a shopping receipt summary table, and adding a storage address of the shopping receipt to the table entry corresponding to the shopping receipt in the shopping receipt summary table, wherein the basic information comprises a merchant and time of purchase;
identifying purchase information of each item of at least one item in the shopping receipt, adding the purchase information of each item to an item summary table, and associating a shopping receipt corresponding to each item with a table entry corresponding to each item in the item summary table, wherein the purchase information of each item comprises the merchant, the time of purchase, an item name, an item quantity, and unit price of each item; and
making a life reminder according to the item summary table.

12. A non-transitory computer-readable storage medium, wherein the readable storage medium stores a program, the program, when executed by a processor, implements:
acquiring a shopping receipt by at least one of importing an online shopping receipt or receiving an electronic offline shopping receipt;
identifying basic information in the shopping receipt, adding the basic information to a table entry corresponding to the shopping receipt in a shopping receipt summary table, and adding a storage address of the shopping receipt to the table entry corresponding to the shopping receipt in the shopping receipt summary table, wherein the basic information comprises a merchant and time of purchase;
identifying purchase information of each item of at least one item in the shopping receipt, adding the purchase information of each item to an item summary table, and associating a shopping receipt corresponding to each item with a table entry corresponding to each item in the item summary table, wherein the purchase information of each item comprises the merchant, the time of purchase, an item name, an item quantity, and unit price of each item; and
making a life reminder according to the item summary table.

13. The method of claim 1, wherein the shopping receipt summary table is used to manage the shopping receipt.

14. The method of claim 5, wherein generating the shopping receipt template corresponding to the merchant of the shopping receipt comprises:
reminding the user to select a position of purchase information of each item of at least one item in the shopping receipt;
receiving the position of the purchase information of each item selected by a user; and
generating the shopping receipt template according to the position of purchase information of each item.
